(19) United States
(12) Patent Application Publication
(10) Pub. No.: US 2001/0031060 A1
(43) Pub. Date: Oct. 18, 2001

(54) Compact speaker system

(76) Inventor: Robert W. Carver, Snohomish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 09/757,379

(22) Filed: Jan. 8, 2001

Related U.S. Application Data
(60) Provisional application No. 60/175,143, filed on Jan. 7, 2000.

(51) Int. Cl. H04R 1/02; H04R 1/20

(52) U.S. Cl. 381/345; 381/348

(57) ABSTRACT

Disclosed is a compact speaker system in which each speaker unit includes a folded ribbon loudspeaker that is mounted on the forward face of the speaker unit housing. Mounted on each side of the speaker housing is a woofer with the region in which the woofers are mounted being sealed and of relatively small volume. Each woofer is constructed to allow relatively long voice coil excursion and hence, high sound output levels. In addition, the woofers are constructed to withstand box pressure substantially greater than 0.2 lbs/in² that is created that is created within the sealed portion of the speaker housing when the woofers are being driven at high output levels. Signal processing circuitry is included for processing each channel of multi-channel audio programming such as surround sound. The signal processing arrangements of the invention include circuit stages to control channel gain over the low frequency range, the mid-frequency range and the high frequency range. An adaptive low pass filter circuit is provided with control circuitry that modifies the low frequency gain characteristic when high intensity low frequency signals are present that would otherwise cause the woofers to be over driven and possibly damaged. A sound pressure limiter circuit and associated control circuit is provided to establish channel gain so that the signal supplied to the woofers exhibit little or no clipping. A circuit arrangement is provided for synthesizing surround sound signals for the center channel and left and right surround channels when stereophonic programming is present.

### RELATED APPLICATIONS

This application is related to, and claims the filing benefit of, copending United States Provisional Patent Application No. 60/175,143 filed Jan. 7, 2000, which is entitled “Compact Speaker System.”

### FIELD OF THE INVENTION

The present invention relates to small, compact and high quality audio systems. More specifically, the present invention provides speaker units and associated circuitry that operate with a conventional multi-channel power amplifier to provide high-quality reproduction of audio programming at output levels that substantially exceed prior art speaker systems of comparable size.

### BACKGROUND OF THE INVENTION

Over the last several years, there have been significant advances in audio entertainment systems. One advancement that has received widespread acceptance is multi-channel recording and reproduction systems. Current multi-channel sound system standards include THX® (a registered trademark of Lucas Film, Ltd.) and Dolby AC-3 Surround Sound® (a registered trademark of J.C. Penney Inc.). Each of these audio reproduction standards employ five audio channels, including left and right front channels, a center channel and left and right surround channels with each of the channels being associated with loudspeaker units that are physically positioned at the left, right and center of the listening area and at left and right surround positions (i.e., in the left and right rear regions of the listening area).

An additional development that has gained widespread acceptance is the incorporation of subwoofer loudspeakers in both stereophonic and multi-channel audio systems. The subwoofers typically produce audio output over a frequency range that extends from 20 Hz, or lower, to an upper frequency of about 80-120 Hz. Basically, subwoofers extend the frequency range of a sound system and improve the performance of an audio system, especially with regard to very low frequency and often relatively high level audio signal programming that relates to explosions, vehicle crashes, and loud, low frequency sounds such as those that commonly occur in audio visual programming (e.g., movies), and some musical selections. Subwoofers that have particular relevance to the present invention are disclosed and claimed in U.S. Pat. No. 5,937,074, which issued to Robert W. Carver on Aug. 10, 1999 and U.S. Pat. No. 6,130,954, which issued to Robert W. Carver on Oct. 10, 2000.

There also has been a growing demand for audio systems that provide a high level of audio output (sound pressure level), with the demand being based upon a desire to reproduce audio programming at high sound levels and a desire for increased performance with respect to short-term, often transient portions of the audio programming. Prior art attempts to achieve the above-noted objectives and goals have resulted in systems in which the speaker units are very large, complex and expensive. The size of the speaker units associated with the prior art is especially significant in that they are not suitable for many homes and other environments, both from the standpoint of the space occupied by the loudspeakers, and from the standpoint of aesthetics. In many cases, the size and cost of prior art arrangements has provided no realistic option other than systems employing small loudspeakers that cannot match the performance of prior art large loudspeaker systems and are incapable of producing audio output at high sound pressure levels.

### SUMMARY OF THE INVENTION

The present invention provides a system in which the loudspeaker units are substantially smaller in size than prior art loudspeaker units capable of operating at a comparable sound output level. For example, in the currently preferred embodiments of the invention, the speaker units are 7.8 inches high, 4 inches wide and 5.2 inches deep. Despite the speaker unit's relatively small size, each speaker unit is capable of producing an output level of approximately 105 dB SPL, when used in a system that employs a conventional high quality power amplifier having per channel output power rating on the order of 200-600 watts. High power output capability is not the only advantage of the present invention in that the quality of the sound produced by the invention (fidelity and other performance characteristics) meets, and in many cases exceeds, the performance achieved by far more costly and larger prior art systems. With respect to the quality of the sound produced, one impressive feature of the invention is the production of a sound field in which the various sources of the sound being reproduced are not perceived as originating at one or another of the system loudspeakers. More specifically, and by way of example, the instruments and vocalists in musical performances are perceived as being at various positions within the listening area.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 depicts the exterior of a speaker unit of the invention;

FIG. 2 is a cross-sectional view of the woofers employed in the practice of the invention;

FIG. 3 is an exploded view of the speaker unit of FIG. 1;

FIG. 4 diagrammatically depicts an exemplary folded ribbon speaker employed in the practice of the invention;

FIG. 5 illustrates the magnetic fields established by six bar magnets that are employed in the folded ribbon speaker shown in FIG. 5;

FIG. 6 is a block diagram illustrating the circuit stages employed in the left and right front channels of the currently preferred embodiments of the invention;

FIG. 7 is a block diagram illustrating the circuit stages employed in the center channel of the currently preferred embodiments of the invention;

FIG. 8 is a block diagram illustrating the circuit stages employed in the left and right surround channels of the currently preferred embodiments of the invention;

FIG. 9 is a block diagram illustrating the circuit stages employed in a subwoofer channel of the currently preferred embodiments of the invention;

FIG. 10 schematically depicts an exemplary input stage for the left and right front channel of FIG. 6, the center channel of FIG. 7, the left and right surround channels of FIG. 8 and the subwoofer channel of FIG. 9;

FIG. 11 schematically depicts a wall room corner circuit suitable for use as the wall room corner circuit stage that is employed in the left and right front channels of FIG. 6, the center channel of FIG. 7, and the left and right surround channels of FIG. 8;

FIG. 12 schematically depicts an adaptive low pass filter and an excursion limiter suitable for use as the low pass filter stage and excursion limiter stage of the left and right front channels of FIG. 6, the center channel of FIG. 7, and the left and right surround channels of FIG. 8;

FIG. 13 schematically depicts a lower mid-range amplifier and an upper mid-range amplifier that are suitable for use as the lower mid-range amplifier and upper mid-range amplifier stages of the left and right front channels of FIG. 6, the center channel of FIG. 7, and the left and right surround channels of FIG. 8;

FIG. 14 schematically depicts a sibilance filter suitable for use as the sibilance filter stage of the left and right front channels of FIG. 6, the center channel of FIG. 7, and the left and right surround channels of FIG. 8;

FIG. 15 schematically depicts an SPL limiter suitable for use as the SPL limiter stage of the left and right front channels of FIG. 6, the center channel of FIG. 7, and the left and right surround channels of FIG. 8, and, in addition, schematically depicts a control circuit for controlling the operation of the depicted SPL limiter;

FIG. 16 schematically depicts a tone amplifier suitable for use as the tone amplifier stage of the left and right front channels of FIG. 6, the center channel of FIG. 7, and the left and right surround channels of FIG. 8;

FIG. 17 schematically depicts a floorbounce amplifier suitable for use as the floorbounce amplifier of the left and right front channels of FIG. 6, the center channel of FIG. 7 and the left and right surround channels of FIG. 8;

FIG. 18 schematically depicts an output circuit suitable for use as the output circuit stage of the left and right front channels of FIG. 6, the center channel of FIG. 7, the left and right surround channels of FIG. 8, and the subwoofer channel of FIG. 9; and

FIG. 19 schematically depicts an accent matrix circuit that is employed in the currently preferred embodiments of the invention to synthesize or transform conventional stereophonic programming into multi-channel programming that includes signals for the center channel of FIG. 7, the left and right surround channels of FIG. 8 and the subwoofer channel of FIG. 9.

### DETAILED DESCRIPTION OF THE PREFERRED EMBODIMENT

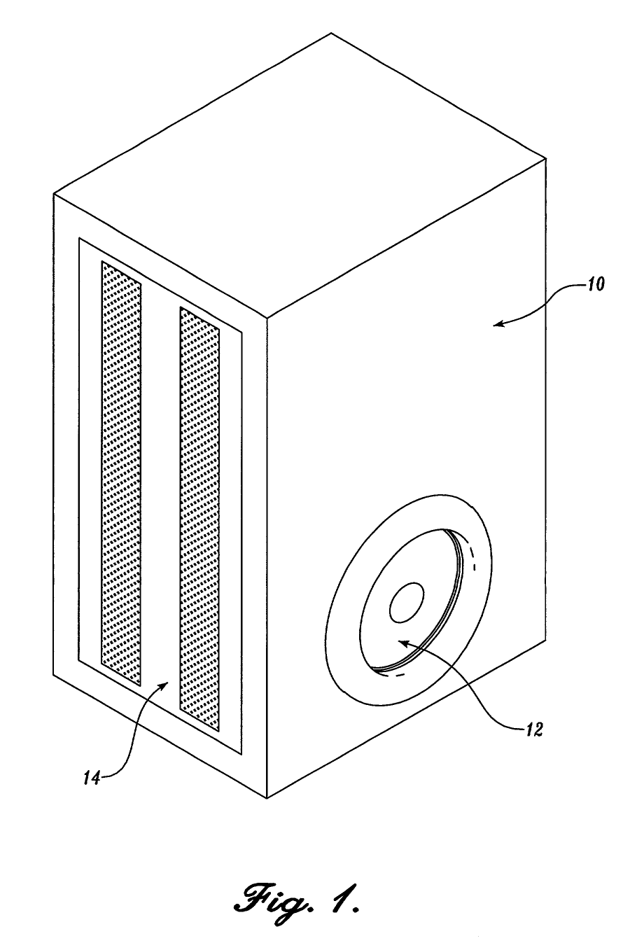

Turning now to the manner in which the invention is configured and arranged, FIG. 1 depicts the exterior of a speaker unit of the invention (generally indicated by reference numeral 10). As is indicated in FIG. 1, the speaker unit 10 includes three loudspeakers. Specifically, located on the left and on the right side of the speaker unit 10 is a woofer 12 for producing output over the lower portion of the input signal frequency range. For example, in one current embodiment of the invention, the woofers 12 generate output over a frequency range that extends from about 80 Hz to about 400 Hz. In a second, lower cost embodiment of the invention, the woofers 12 operate over a frequency range that extends from about 80 Hz to about 1.5 KHz.

With continued reference to FIG. 1, the third speaker 14 of the depicted speaker unit is located on the front of the speaker unit 10 and is rectangular in shape. As shall be described in more detail, the forward facing third speaker 14 is of a folded ribbon configuration. The currently preferred embodiments of the invention utilize a folded ribbon speaker 14 that is 5.4 inches high and about 3 inches wide. As previously mentioned, the exterior dimensions of the currently preferred embodiments of speaker unit 10 are 7.8 inches high, 4 inches wide, and 5.2 inches deep.

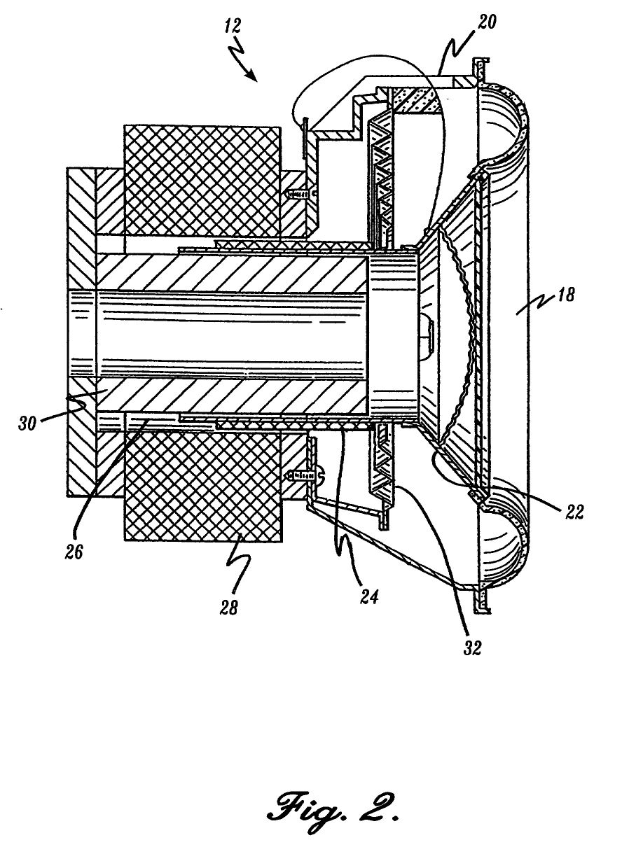

From the standpoint of general configuration and principles of operation, the woofers 12 of the present invention generally correspond to the drivers disclosed in the previously mentioned U.S. Pat. No. 5,937,074, which issued to Robert W. Carver on Aug. 10, 1999 and U.S. Pat. No. 6,130,954, which issued to Robert W. Carver on Oct. 10, 2000. U.S. Pat. Nos. 5,937,074 and 6,130,954 are hereby incorporated by reference relative to the general arrangement and operating principles of the therein disclosed drivers. As is indicated in FIG. 2, the major components of woofers 12 that are used in the practice of this invention include an annular surround 18 that extends radially between a circular frame 20 (e.g., the forward end of a speaker basket) and the outer periphery of a speaker cone 22. Extending rearwardly from, and attached to the inner end of the speaker cone 22, is a voice coil 24. As is conventional, the voice coil 24 is positioned within a magnetic gap 26 that is formed between the inner surface of an annular magnet 28 and a spaced-apart pole piece 30 that extends through the central opening of the annular magnet 28. A spider 32 extends outwardly from a position forward of the voice coil 24 to the woofer frame or basket 20 to position the voice coil 24 within the magnetic gap 26. Collectively, the surround 18 and spider 32 maintain the voice coil 24 in non-contracting alignment within the magnetic gap as the voice coil 24 moves in a reciprocating manner to drive the speaker cone 22 and produce a sound field representative of the electrical signal that is supplied to the voice coil 24.

In accordance with the invention, the woofer surround 18 is constructed to allow relatively long voice coil excursion and hence, high sound output levels. In addition, since the portion of the speaker unit housing the two woofers 12 is sealed and is small in volume, the surround 18 is constructed in a manner that withstands relatively high box pressures (substantially greater than 0.2 lbs/in²) that are created within the speaker unit 10 when the woofers are being driven at high output levels. Surrounds suitable for use in the woofers of the invention can be formed of an expanded synthetic cellular foam such as expanded cellular polyethylene and other materials such as butyl rubber. Regardless of the material employed, the surrounds exhibit a radial rigidity that is sufficient to maintain the forward end of the speaker cone 22 and voice coil 24 properly positioned during maximum speaker excursion while simultaneously having sufficient flexibility and pliancy in the longitudinal direction to allow the voice coil 24 and speaker cone 22 to travel throughout the intended excursion range. In the currently preferred embodiments of the invention, the surround 18 is of a half roll design, with the surround being on the order of 7/16-inch. In those preferred embodiments, the surround 18 and other major components of the woofers are mounted within a conventional basket that houses conventional 3-inch speakers. Additional information that relates to the construction of suitable surrounds for long excursion drivers such as the woofers of this invention that operate in a high box pressure environment is included in the previously referenced U.S. Pat. Nos. 5,937,074 and 6,130,954.

In the currently preferred woofer embodiments, the peak-to-peak excursion of the voice coil 24 is on the order of 8/10-inch with the effective piston diameter of the woofer 12 being approximately 3 inches. The internal sealed volume of the speaker units 10 of the currently preferred embodiments of the invention is on the order of 40 cubic inches. When the two woofers 12 are driven at maximum excursion, the pressure asserted on the internal walls of the speaker unit 10, and the interior surface of the surround 18, is thus on the order of 2½ lbs/in², a value which substantially exceeds box pressure of prior art speaker units of comparable size. For example, a pair of prior art woofers mounted in an enclosure having an internal volume of approximately 40 cubic inches and driven with a 7-30 watt amplifier, produce box pressures of less than 0.2 lbs/in².

As is the case with the drivers disclosed and claimed in U.S. Pat. Nos. 5,937,074 and 6,130,954, woofers employed in the practice of this invention are constructed for highly efficient operation in order to avoid high voice coil current that would otherwise cause overheating and potentially destroy the voice coil winding. In that regard, it is necessary for the woofers 12 to be arranged to exhibit a (Bl)²/rₑ ratio that is higher than the ratio employed in conventional woofers of comparable size, where B represents the magnetic field within the magnetic gap 26, l represents the length of the voice coil 24 winding located within the magnetic gap, and rₑ is the DC resistance of the voice coil 24. Stated in different terms, the woofers 12 are of a high back emf design to limit voice coil current (and hence, heating of the voice coil 24). In the previously mentioned currently preferred embodiments of the woofers 12, the quantity Bl is on the order of 10-12 and rₑ of each woofer 12 is approximately 3 Ohms. Since the voice coils 24 of the two woofers 12 are connected in parallel, the DC resistance of the interconnected woofers is approximately 1.5 Ohms, which allows the woofers 12 to be driven by standard audio amplifiers that exhibit an output power in the 200-600 watt range.

As will be recognized by those skilled in the art, to obtain a relatively high Bl, it is necessary to employ a magnet that produces a relatively high magnetic field and/or employ a voice coil with a substantial number of windings. In the currently preferred embodiments of the invention, a voice coil 24 of 1-inch in diameter and on the order of 1-inch in length is employed using six winding layers or a thicker four layer winding arrangement in order to provide the above-mentioned DC resistance of approximately 3 Ohms. In these preferred embodiments, the magnets 28 provide a magnetic field, B, on the order of from about 1 Tesla to about 2.2 Tesla.

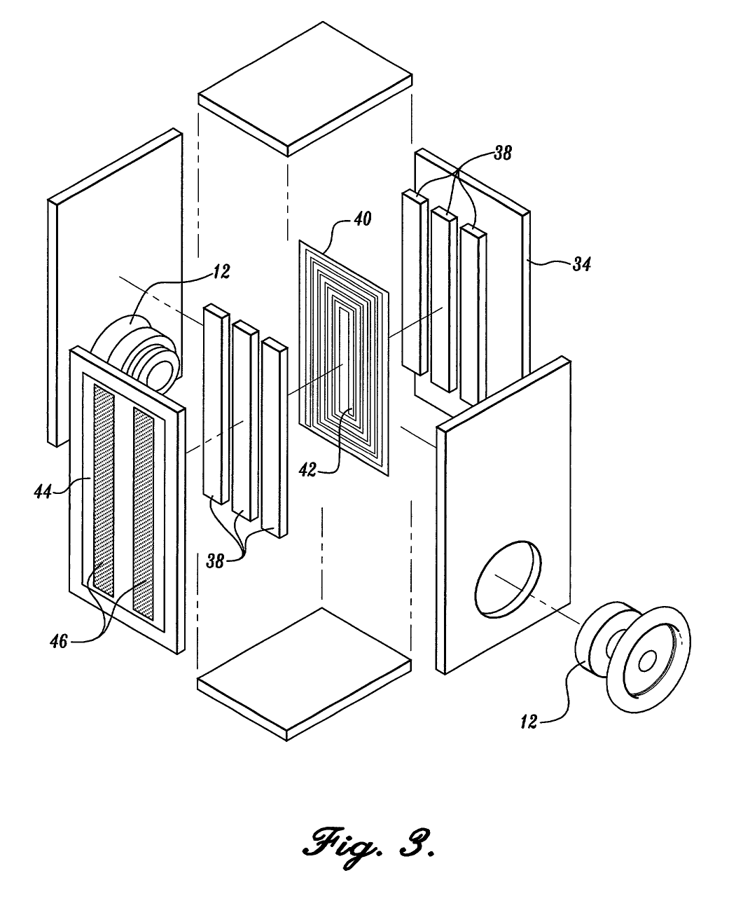

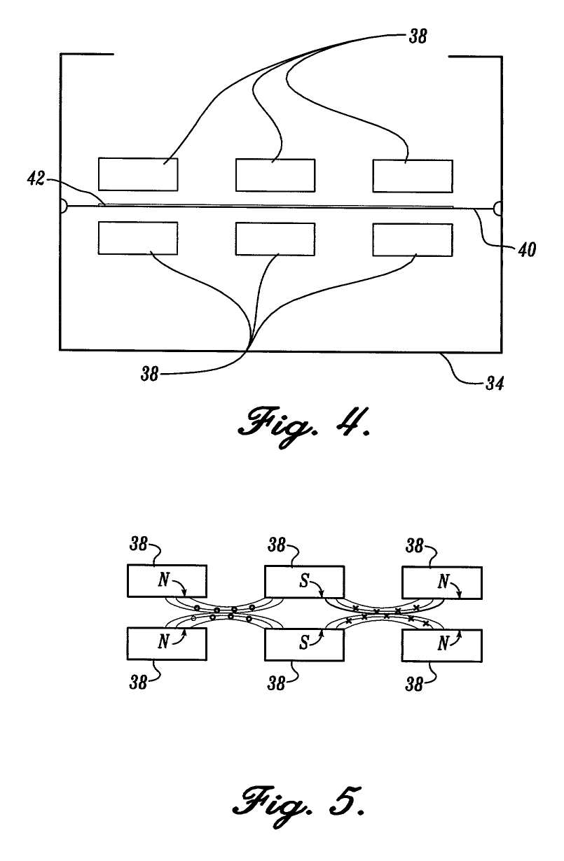

As previously mentioned, the arrangement of the invention shown in FIG. 1 includes a forward facing folded ribbon speaker 14 in addition to the two woofers 12 that are located on the opposing sides of the speaker unit 10. The construction of the folded ribbon speaker 14 is indicated in FIGS. 3-5. As is shown in the exploded view of FIG. 3, the major components of the folded ribbon speaker 14 include a back cover 34, six bar magnets 38, a thin dielectric sheet 40 that includes a conductive pattern 42 that forms the voice coil of the folded ribbon speaker 14 and a front cover 44. As is indicated in FIGS. 3-5, the six bar magnets 38 extend vertically and are arranged in two sets of three magnets. One set of three magnets 38 is located in spaced-apart juxtaposition with one surface of the conductor-bearing dielectric sheet 40, which also extends vertically in parallel spaced-apart relationship with the front cover 44 of the folded ribbon speaker 14. The second set of three magnets 38 is spaced-apart from the opposite side of the dielectric sheet 40 with each vertically extending magnet 38 being in substantially parallel spaced-apart relationship with the dielectric sheet 40 when no signal is applied to the folded ribbon speaker 14. As is indicated in FIG. 4, the dielectric sheet 40 is supported along its edges and is under sufficient tension to maintain the sheet 40 substantially parallel to the surfaces of the two sets of bar magnets 38. Since the folded ribbon speaker 14 includes a back cover 34 (indicated in FIGS. 3 and 4), it can be noted that the folded ribbon speaker 14 is not subject to the high box pressures produced by the woofers 12, which operate in the previously mentioned manner within a sealed region of each speaker unit 10.

As is indicated in FIG. 3, the conductive pattern 42 on the surface of the dielectric sheet 40 essentially is a spiral in which each turn is basically of rectangular configuration. Although not specifically shown in FIG. 3, the ends of the conductive pattern 42 are connected to terminals that are, in turn, connected to the output terminals of a power amplifier, such as the previously mentioned conventional amplifiers that produce 200 to 600 watts per channel.

In the currently preferred embodiments, the ribbon speaker 14 is on the order of 5½ inches in height and 3 inches wide. In these embodiments, the dielectric sheet 40 is approximately 3 thousandths of an inch thick and is constructed of a polyimide sheet such as Kapton® (a trademark of E.I. du Pont de Nemours and Company). The conductive pattern 42 of these embodiments is formed of an aluminum foil, with the width of the conductor being approximately 1/16 inch and the spacing between the conductors being on the order of 20 to 30 thousandths of an inch to form an eleven turn spiral-like rectangular pattern.

In the currently preferred embodiments of the invention, the magnet strength of each bar magnet 38 is on the order of 0.25 Tesla and each bar magnet 38 is approximately 7/16 inch wide, ¼ inch thick and of a length that causes each set of these magnets to extend over the full vertical height of the conductor-bearing dielectric sheet 40. In these embodiments, the bar magnets 38 of each set of bar magnets are spaced apart from one another by a distance of approximately ½ inch. As is indicated in FIG. 5, the oppositely disposed faces of each pair of bar magnets 38 that are in vertical alignment with one another are of like magnetic polarity. In the arrangement shown in FIG. 5, the oppositely disposed left and right side pairs of bar magnets 38 are arranged with the north magnetic poles facing one another. The centrally located oppositely disposed pair of bar magnets 38 are arranged with the south magnetic poles facing one another. Thus, the magnetic field established in the region between the oppositely disposed set of three bar magnets 38 (i.e., the region in which the dielectric sheet 40 is located) is as depicted in FIG. 5. Further, as is indicated in FIG. 5, when the amplifier signal is of one polarity (positive or negative), current flows upwardly along the portion of the conductive pattern 42 that is located on the left side of the dielectric sheet 40 and downwardly through the portion of the conductive pattern 42 that is located on the right side of the dielectric sheet 40. When the polarity of the signal supplied to the ribbon speaker 14 by a power amplifier reverses, the current direction shown in FIG. 5 reverses. As will be recognized by those skilled in the art, this arrangement causes the dielectric sheet 40 to be deflected toward and away from the two sets of three spaced-apart bar magnets 38, with the direction of deflection being determined by the polarity of the signal supplied to the folded ribbon speaker 14. As is also known by those skilled in the art, the deflection of the dielectric sheet 40 and hence, the sound level produced by the folded ribbon speaker 14 is determined by the physical characteristics of the dielectric sheet 40 and its mounting (which establish the force required for a given amount of deflection) and the force that results due to current flow through the conductive pattern 42. As is further known, the force exerted on the conductive pattern 42 and hence, the dielectric sheet 40 is determined by the vector cross product of the magnetic field established by the magnets 38 and the current that flows through the conductive pattern 42.

The currently preferred embodiments of the invention are arranged so that the folded ribbon speaker 14 is capable of producing an output sound level that is approximately the same as the sound level produced by a prior art single turn ribbon speaker having a height on the order of five feet. Folded ribbon speakers for use in embodiments of the invention that operate at an output power level that is different from the currently preferred embodiments of the invention can be realized by suitably selecting the speaker bar magnets 38 and the number of turns used in the conductive pattern 42 that services as a voice coil.

Employing a folded ribbon speaker 14 in the practice of this invention is especially advantageous. In particular, sound waves emerging from the speaker face (e.g., openings formed in the front cover 44 of the currently preferred folded ribbon speaker 14) travel outwardly from the speaker with little sound energy being directed upwardly toward the ceiling or downwardly toward the floor. Thus, the sound field produced by the folded ribbon speakers 14 is not deleteriously affected to a significant degree by signal reflection from the floor or ceiling of the listening area. This characteristic of the folded ribbon speakers 14 is one of the aspects of the invention that result in the earlier mentioned production of a sound field in which the various sources of sound that established the program being reproduced are not perceived as originating at one or another of the system loudspeakers, but are perceived as originating at specific positions within the sound field that is established by the invention. Another aspect of the invention that contributes to this feature of the invention are the hereinafter discussed floorbounce amplifiers that are located in each channel of the currently preferred signal processing and control circuitry. Further, it has been determined that this feature of the invention also can be attributed in part to the respective frequency responses of the woofers 12 and the folded ribbon speaker 14 that are employed in the speaker units 10 of the invention. In that regard, the frequency responses are established so that the frequency range of the woofers 12 overlaps the frequency range of the folded ribbon speaker 14 by at least one octave. For example, in the currently preferred embodiments of the invention in which the frequency range of the woofers 12 extends from approximately 80 Hz to 400 Hz, the low frequency roll off of the folded ribbon speaker 14 is such that most of the acoustic output of the speaker unit 10 is produced by the folded ribbon speaker 14 at frequencies above 400 Hz, but a significant amount of acoustic output is produced by the folded ribbon at frequencies on the order of 200 Hz.

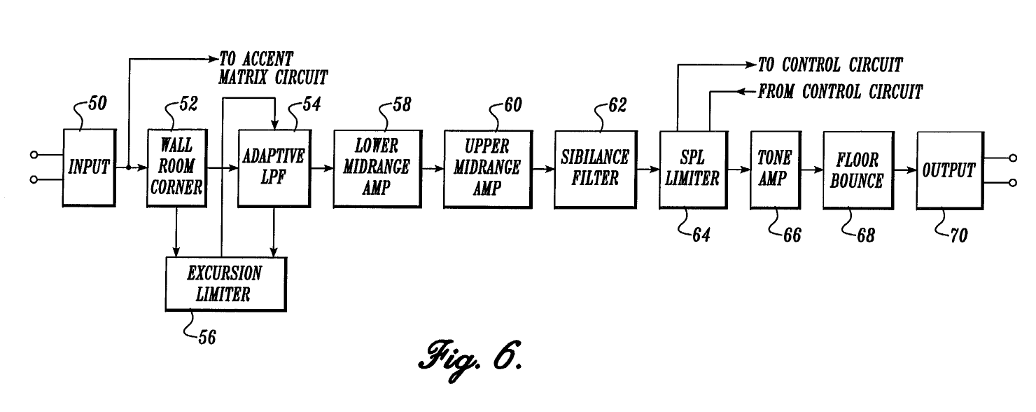

FIGS. 6, 7, 8 and 9 respectively depict, in block diagram format, the signal processing circuitry of the left and right front channels of the currently preferred embodiments of the invention, the center channel signal processing circuitry of the currently preferred embodiments of the invention, the left and right surround channels of the currently preferred embodiments of the invention and a subwoofer signal processing channel that is employed in the currently preferred embodiments of the invention. In the currently preferred embodiments of the invention, the circuitry indicated in FIGS. 6-9 and additional signal processing and control circuitry described herein are mounted in a small metal enclosure similar to the enclosures typically employed for housing audio and audio visual home entertainment equipment.

As is shown in FIG. 6, identical left and right front channels of the currently preferred embodiment of the invention include an input stage 50 for receiving left and right audio signals supplied by conventional sources of stereophonic or surround sound audio and audio visual devices such as tape players, compact disc players, digital video disc and laser disc players and television and radio receivers. Preferably, input stage 50 provides a first input connector for receiving an unbalanced input signal and a second input connector for receiving a balanced input sign. Various arrangements known in the art are suitable for use as input stage 50, with a schematic diagram of the circuit arrangement that is employed in the currently preferred embodiments of the invention being depicted in FIG. 10 and being described hereinafter.

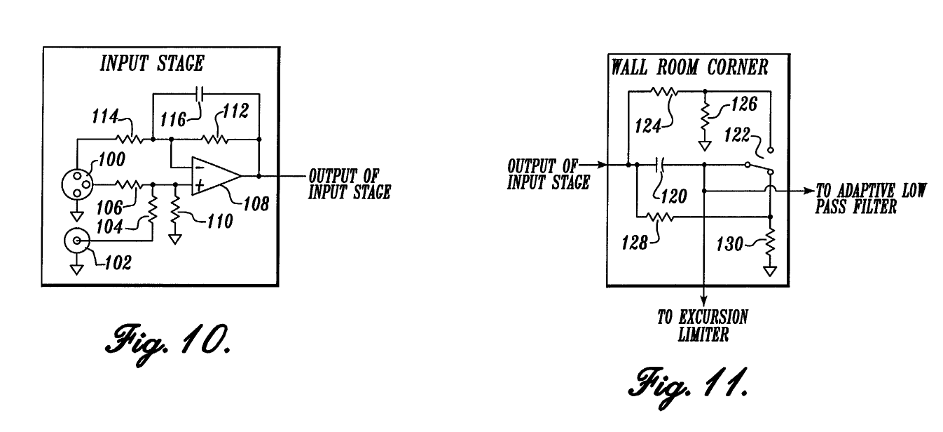

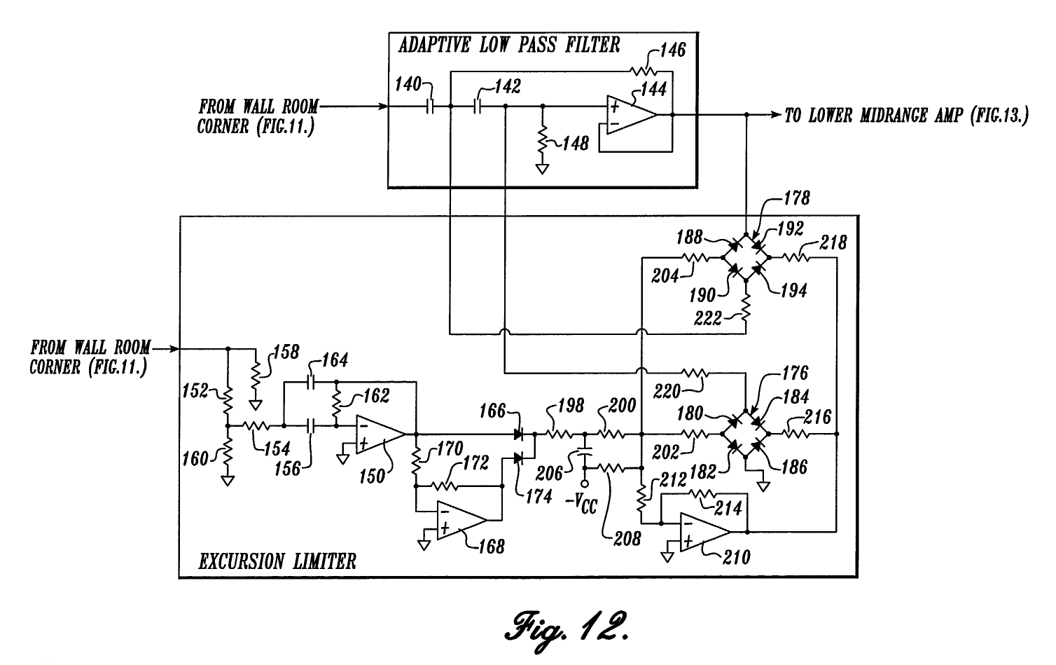

In the left and right front channel arrangement of FIG. 6, the output of input stage 50 is supplied to an accent matrix circuit (not shown in FIG. 6). As shall be described relative to the exemplary accent matrix circuit depicted in FIG. 19, the accent matrix circuit functions to transform the right and left channel input signals into multi-channel (surround sound) program signals and, in the currently preferred embodiments, also provides a subwoofer input signal. As is indicated in FIG. 6, the output signal of input stage 50 is also coupled to a wall room corner circuit 52. Wall room corner circuit 52 includes a switch (not shown in FIG. 6), which is positioned in a first position when the associated speaker unit (e.g., the left front speaker) is located in the corner of a room and is in a second position when the associated speaker unit is located along the expanse of a wall or is otherwise positioned so that sound emitted from one of the speaker unit woofers is not subject to substantial reflection from a nearby wall or other large object. Included within each wall room corner circuit is circuitry that functions to enhance channel performance for each of these two spatial orientations. An exemplary, passive circuit arrangement that is used as the wall room corner circuit of the currently preferred embodiments of the invention is described herein relative to FIG. 11.

In FIG. 6, the signal provided by the wall room corner circuit 52 is coupled to the input of an adaptive low pass filter circuit 54 and the input of an excursion limiter circuit 56. The excursion limiter circuit 56 operates in conjunction with components in the feedback path of the adaptive low pass filter circuit 54 to reduce the gain of the adaptive low pass filter 54 during short periods in time in which the applied audio signal exceeds a predetermined level. The low pass filter circuit 54 and excursion limiter circuit 56 that are employed in the currently preferred embodiments of the invention are schematically depicted in FIG. 12 and are described hereinafter.

Immediately following the adaptive low pass filter circuit 54 of FIG. 6 is a lower mid-range amplifier 58 and an upper mid-range amplifier 60. The transfer functions of the lower mid-range amplifier 58 and the upper mid-range amplifier 60 exhibit reduced gain in selected regions of the channel frequency response. In the currently preferred embodiments, the transfer function of the lower mid-range amplifier 58 causes reduced gain over a two octave bandwidth that is centered at approximately 500 Hz. In those currently preferred embodiments, the transfer function of the upper mid-range amplifier 60 is established to reduce the output of the upper mid-range amplifier over a two octave frequency band that is centered at approximately 4 KHz. The circuit arrangements of lower mid-range amplifier 58 and upper mid-range amplifier 60 that are used in the currently preferred embodiments of the invention are schematically depicted in FIG. 13 and are described herein.

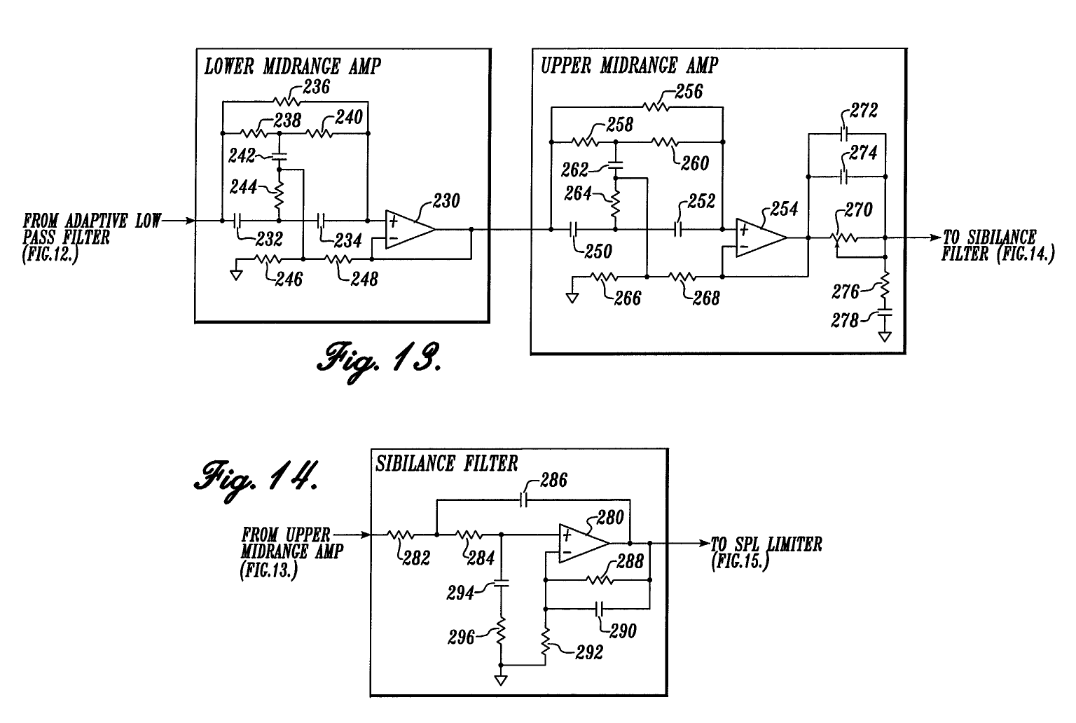

Continuing with the description of the identical left and right front signal processing channels of FIG. 6, the output signal supplied by the upper mid-range amplifier 60 is coupled to a sibilance filter circuit 62. The sibilance filter circuit 62 functions to at least partially eliminate the “s” sounds that sometimes occur in programming such as musical or other programs that include vocal content. The schematic diagram for the sibilance filter circuit employed in the currently preferred embodiments of the invention is shown in FIG. 14 and is described hereinafter.

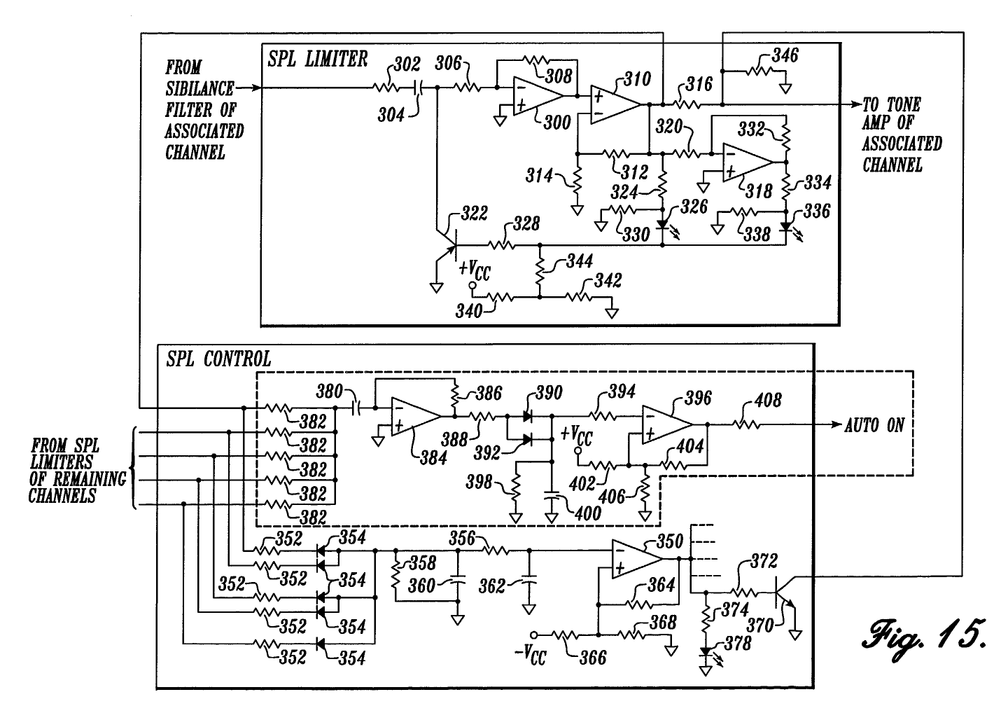

Connected to the output of the sibilance filter circuit 62 of FIG. 6 is an SPL (sound pressure level) limiter 64. The SPL limiter 64 functions in combination with an SPL control circuit (not shown in FIG. 6) to limit the output of the sound pressure level produced by the associated speaker unit to a predetermined level, which is on the order of 105 dB in the currently preferred embodiments of the invention. In that regard, the topology and component values of the SPL limiter 64 and the associated SPL control circuit are established in accordance with the standard or conventional gain characteristics of the power amplifiers that are used in conjunction with the invention to drive the speaker units of the invention. In that regard, the SPL control circuit that is associated with the SPL limiter 64 processes the signal supplied to the SPL limiter 64 to produce a control signal that is representative of the output signal being supplied to the associated speaker unit 10 over a predetermined period of time. If the control signal indicates that the speaker unit 10 is being driven beyond the desired output level (i.e., signal clipping is occurring or is imminent), the gain of the SPL limiter and hence, channel gain, is reduced to maintain the output sound level below the desired limit and thereby avoid signal clipping by the amplifier channel that drives the associated speaker unit 10. A schematic diagram of the SPL limiter circuit and the associated SPL control circuit that is used in the currently preferred embodiments of the invention is depicted in FIG. 15 and is described herein.

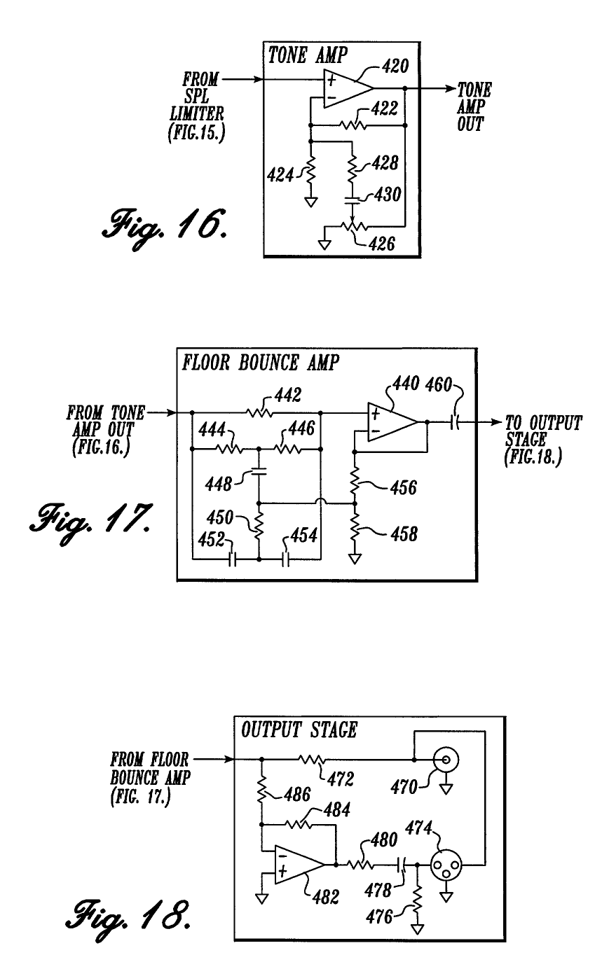

As is further shown in FIG. 6, the output of the SPL limiter circuit 64 is connected to the input terminal of a tone amplifier 66. The tone amplifier 66 functions to control the high-frequency content of the signal produced by the system circuitry. The tone amplifier 66 employed in the currently preferred embodiments of the invention is depicted in FIG. 16 and is described herein.

The output of the tone amplifier 66 is connected to the input terminal of a floorbounce amplifier 68. The transfer characteristic of the floorbounce amplifier 68 is established to reduce the effect of signal reflection or “bounce” of the low frequency audio output signals that are generated by the woofers 12 of the associated speaker unit 10. These reflected signals largely result from sound that may be reflected from the floor surface in the listening area. As is known in the art, reflected signals detract from the quality of the sound produced by an audio system because reflected signals arrive at a listener's ears later than signals that travel directly toward the listener. In the currently preferred embodiments of the invention, each floorbounce amplifier 68 exhibits a transfer function that reduces signal amplitude over a frequency range of about one-half to about one octave, with the center frequency being on the order of 200 Hz and the mid-band attenuation being on the order of 3 dB. An exemplary circuit arrangement for achieving the transfer function employed in the currently preferred embodiments of the invention is schematically depicted in FIG. 17.

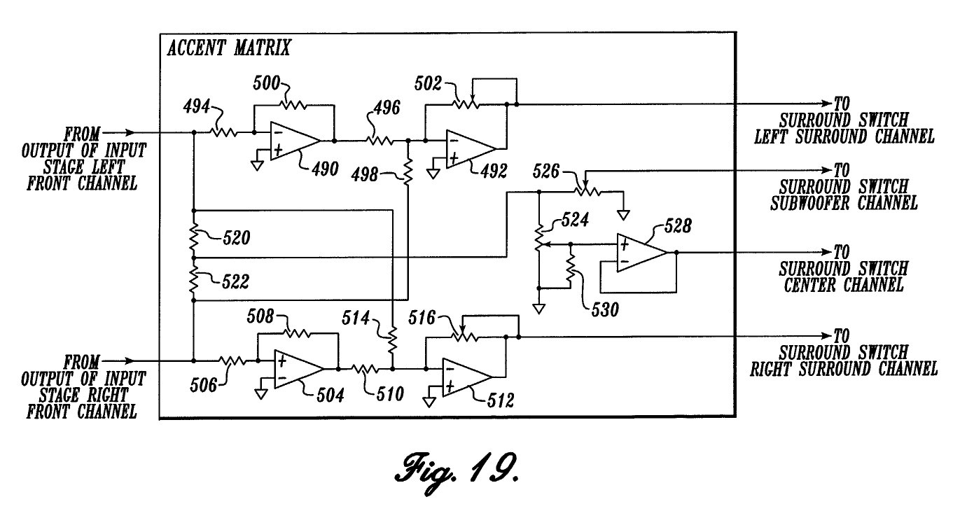

The final stage of the identical left and right front channels depicted in FIG. 6 is an output stage 70, which is arranged so that the channel output signal can be connected to a channel of a power amplifier. As previously mentioned, each channel of the circuitry of the invention is connected to an associated channel of a conventional power amplifier when the invention is installed in an audio system, with the output of the power amplifier being connected to drive the associated speaker unit 10 of the invention. Like the input stage 50, output stage 70 preferably provides both balanced and unbalanced signal connection capability. An exemplary circuit that is used as the output 70 of the currently preferred embodiments of the invention is schematically depicted in FIG. 18 and is described herein.

As previously noted, FIG. 7 is a block diagram illustrating the center channel signal processing of the currently preferred embodiments of the invention. Comparing the center channel configuration of FIG. 7 with the identical left and right front channel configuration of FIG. 6, it could be noted that the channel configurations are basically identical with one exception. Specifically, as is shown in FIG. 7, the output signal provided by the input stage 50 of the center channel is not directly connected to a wall room corner circuit 52. Instead, in the center channel shown in FIG. 2, the output signal of the input stage 50 is supplied to a wall room corner circuit 52 via a surround switch 72 and a cascade-connected buffer amplifier 74.

Surround switch 72 functions to supply the signals supplied by input stage 50 to buffer amplifier 74 and hence, to wall room corner circuit 52 when a center channel input signal is available at the input of input stage 50. When no input channel signal is available at the input of input stage 50, surround switch 72 is activated so that a center channel signal that is supplied by the accent matrix circuit (FIG. 19) is supplied to buffer amplifier 74 and hence, wall room corner circuit 52. In the arrangement shown in FIG. 7, surround switch 72 includes an npn transistor 76 having its emitter electrode connected to the output of input stage 50 and its collector electrode connected to the input of buffer amplifier 74. The base electrode of npn transistor 76 is connected to an accent matrix on/off terminal 82 via series connected resistors 78 and 80. A capacitor 84 is connected from the junction between resistors 78 and 80 to the circuit negative supply voltage (−V_{cc}). In operation, a voltage is applied to accent matrix on/off terminal 82 that causes npn transistor 76 to turn ON when a center channel signal is present at the input of input stage 50. When no signal is present at the input of input stage 50, the potential at the accent matrix on/off terminal 82 is at a potential that causes npn transistor 76 to be OFF. With npn transistor 76 in the OFF state, a synthesized center channel signal is supplied to the input of buffer amplifier 74 from the accent matrix circuit of FIG. 19, with the synthesized center channel signal being produced in a manner that will be described relative to the accent matrix circuit depicted in FIG. 19.

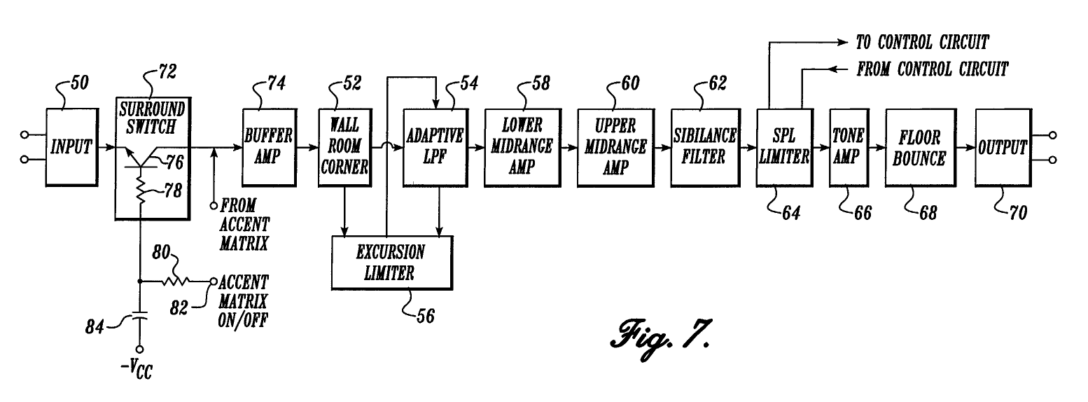

FIG. 8 depicts, in block diagram format, the identical left and right surround channel signal processing of the currently preferred embodiments of the invention. Comparing the block diagram arrangement of the surround channels shown in FIG. 8 with the block diagram center channel processing arrangement shown in FIG. 7, it will be noted that the two arrangements are identical. The difference between the arrangements of FIGS. 7 and 8 is in the manner in which the input stages 50 and the surround switches 72 are connected. Specifically, the input signals to the input stages 50 of the identical left and right surround channels shown in FIG. 7 are respectively supplied by the left and right surround signals of multi-channel audio programs, when multi-channel programming is present. Similarly, the accent matrix signals supplied to the buffer amplifiers 74 of the identical left and right surround channels of FIG. 8 are synthesized left and right surround channel signals that are supplied by the accent matrix circuit of FIG. 19. Although surround switches 72 of FIGS. 7 and 8 are each depicted as being connected to a capacitor 84 and an accent matrix on/off terminal 82 via a resistor 80, the presently preferred embodiments of the invention do not include separate capacitors 84, resistors 80, or accent matrix on/off terminals 82 for each depicted surround switch 72. That is, the currently preferred embodiments of the invention utilize a single accent matrix on/off terminal, resistor 80 and capacitor 84 with resistor 78 of each surround switch 72 being connected to the junction between the single capacitor 84 and single resistor 80.

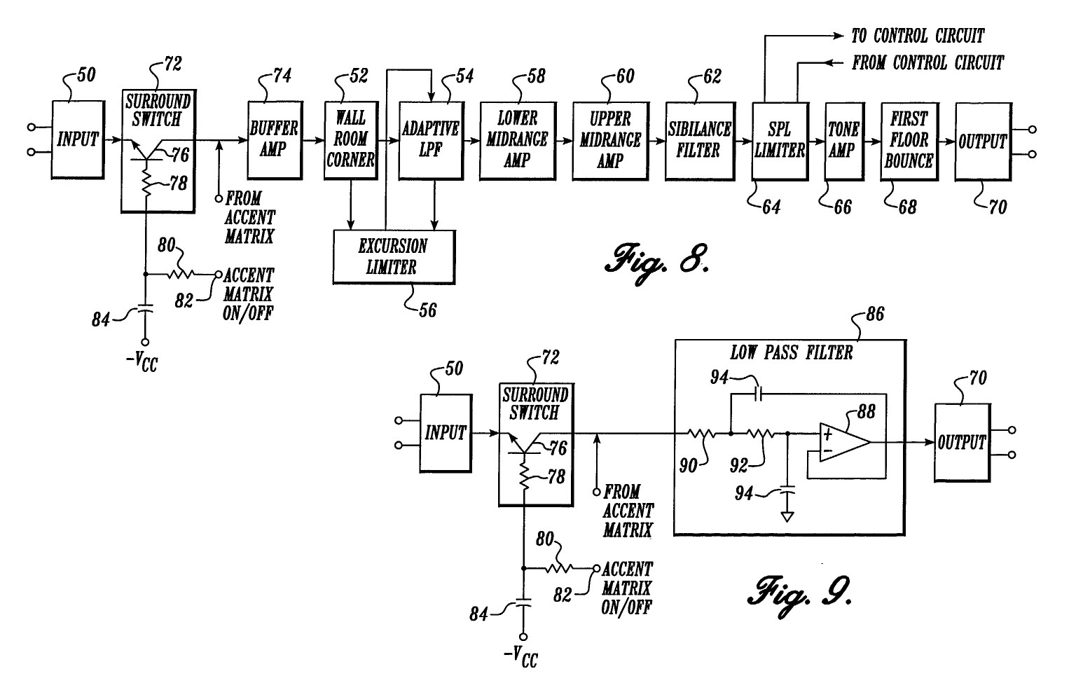

FIG. 9 illustrates, in partial block diagram form, a subwoofer signal processing channel that is used in the currently preferred embodiments of the invention. The subwoofer channel of FIG. 9 includes an input stage 50 which, in the currently preferred embodiments of the invention, is identical to the input stages 50 of the left and right front channels (FIG. 6), the center channel (FIG. 7) and the left and right surround channels (FIG. 8). Connected to the output of input stage 50 of FIG. 9 is a surround switch 72, which in the currently preferred embodiments of the invention is configured in the same manner as the surround switches 72 of the center channel of FIG. 7 and the left and right surround channels of FIG. 8. In the subwoofer signal processing channel of FIG. 9, the output of surround switch 72 (collector electrode of npn transistor 76) is connected to the input of a low pass filter circuit 86. Low pass filter circuit 86 of the arrangement depicted in FIG. 9 includes an operational amplifier 88 having the noninverting input terminal thereof connected to the output of surround switch 72 via series connected resistors 90 and 92. A capacitor 94 is connected between the noninverting input terminal of operational amplifier 88 and signal ground. Feedback is provided from the output terminal of operational amplifier 88 to the junction between resistors 90 and 92 via a capacitor 94 and the output terminal of operational amplifier 88 is directly connected to the operational amplifier inverting input terminal. As is indicated in FIG. 9, a synthesized subwoofer signal is supplied to the input of low pass filter 86 by the previously mentioned accent matrix circuit. In addition, the subwoofer signal processing channel of FIG. 9 includes an output stage 70 that is connected for receiving the signals supplied by low pass filter 86. In the currently preferred embodiments of the invention, output stage 70 is identical to the output stages 70 of the left and right front channels (FIG. 6), the center channel (FIG. 7) and the left and right surround channels (FIG. 8).

FIG. 10 illustrates one arrangement of an input stage that is suitable for use for the input stages 70 described relative to the signal processing channels of FIGS. 6, 7, 8, and 9. The input stage arrangement of FIG. 10 includes a connector 100, such as an XLR connector, for receiving a balanced audio input signal and a connector 102, such as an RCA connector, for receiving an unbalanced input signal. One terminal of the balanced input connector 100 is connected to the noninverting input terminal of an operational amplifier 108 via a resistor 106. The center conductor of the unbalanced input connector 102 is connected to the noninverting input terminal of the operational amplifier 108 via a resistor 104. A resistor 110 is connected between the noninverting input terminal of operational amplifier 108 and signal common. As is further shown in FIG. 10, one input terminal of the balanced input connector 100 and the shell or outer conductor of unbalanced input terminal 102 are connected to signal common. The third terminal of balanced input connector 100 is connected to the output terminal of operational amplifier via series connected resistors 114 and 112. A capacitor 116 is connected between the junction of resistors 112 and 114 and the output terminal of operational amplifier 108. In the depicted arrangement, resistors 106, 110, 112, and 114 are of identical resistance value to achieve a balanced input characteristic.

FIG. 11 depicts the wall room corner circuit used in the currently preferred embodiments of the invention. Included in the depicted wall room corner circuit is a capacitor 120, a switch 122, and resistors 124, 126, 128 and 130. One terminal of capacitor 120 is connected to the input of the wall room corner circuit with the second terminal of capacitor 120 being connected to the wiper contact of switch 122 and, in addition, being connected to supply input signals to the adaptive low pass filter 54 and excursion limiter 56 of the signal processing channel in which the wall room corner unit is employed. When switch 122 is in the position depicted in FIG. 11, resistor 128 is connected in parallel with capacitor 120 and resistor 130 provides a signal path between the output of the wall room corner unit and signal common (ground potential for the signal processing circuitry of the invention). When switch 122 is in the second position, resistor 124 is connected in parallel with capacitor 120 and resistor 126 is connected between the output of the wall room corner circuit and signal common. In the currently preferred embodiments of the invention, resistors 124 and 128 are of equal resistance (3.9 kOhms), capacitor 120 is 1 microfarad and resistors 126 and 130 are 1.2 kOhms and 1.5 kOhms, respectively. With these circuit values, the output of the wall room corner circuit is decreased by 2 dB when switch 122 is in the second position. In the practice of the invention, the decreased output (switch 122 in the second position) improves system performance when the associated speaker 10 is located near the corner of a room or a large object that reflects sound emitted by one of the side firing woofers 12.

FIG. 12 depicts the adaptive low pass filter and excursion limiter (54 and 56, respectively, in FIGS. 6-8) that are employed in the currently preferred embodiments of the invention. As is shown in FIG. 12, the signal supplied by the wall room corner circuit (52 in FIGS. 6-8) provides the input signal to the adaptive low pass filter with the input signal being coupled to the noninverting input of an operational amplifier 144 via series connected capacitors 140 and 142. A resistor 148 is connected between the noninverting input of operational amplifier 144 and signal common. The output terminal of operational amplifier 144 is directly connected to the inverting input terminal of the operational amplifier and additionally is connected to the juncture between capacitors 140 and 142 via a resistor 146.

As was mentioned relative to FIG. 6, an excursion limiter (56 in FIGS. 6-8) is interconnected with the adaptive low pass filter (54 in FIGS. 6-8) to reduce the gain of an associated low pass filter during short periods of time in which low frequency content of the input signal (supplied by the associated wall corner circuit 52) exceeds a predetermined level. More specifically, the excursion limiter operates to increase the corner frequency of the adaptive low pass filter by a predetermined amount and thus, attenuate signals within a low frequency band when high intensity signals within that frequency band are present that would otherwise overdrive the woofers 12. Operating in this manner, the adaptive low pass filter allows the woofers 12 to be driven at high sound pressure levels (high volume), yet provides protection for the woofer during short duration low frequency signal content, such as a loud drum beat or gunfire in audio visual programming. In the currently preferred embodiments of the invention, the corner frequency of adaptive low pass filter 80 Hz and is moved to 160 Hz during short term, high intensity signals that are at or near 80 Hz.

In the arrangement shown in FIG. 12, the signal supplied by the associated wall corner circuit 52 is connected to the inverting input terminal of an operational amplifier 150 via the series connected combination of a resistor 152, a resistor 154 and a capacitor 156. A resistor 158 is connected from the input of the depicted excursion limiter to signal common and a resistor 160 is connected from the junction between resistors 152 and 154 to signal common to thereby form a voltage divider consisting of resistors 152 and 160. The noninverting input terminal of operational amplifier 150 is connected to signal common. Feedback is provided between the output terminal of operational amplifier 150 via a resistor 162 and a capacitor 164 with resistor 162 being connected between the output terminal of operational amplifier 150 and the operational amplifier inverting input terminal and capacitor 164 being connected between the output terminal of operational amplifier 150 and the junction between resistor 154 and capacitor 156.

The output terminal of operational amplifier 150 is connected to the anode of a diode 166 and additionally, is connected to the inverting input terminal of an operational amplifier 168 via a resistor 170. The noninverting input terminal of operational amplifier is connected to signal common with the gain of operational amplifier 168 being established by a resistor 172 that is connected between the output terminal of the operational amplifier and the noninverting input terminal. The output terminal of operational amplifier 168 is also connected to the anode of a diode 174, the cathode of which is connected to the cathode of diode 166.

Continuing with the description of the excursion limiter circuit shown in FIG. 12, during short periods of time in which the signal supplied by the wall room corner circuit of an associated channel exceeds a predetermined value, the gain of the adaptive low pass filter circuit in that channel is controlled by a diode bridge circuit 176 and a diode bridge circuit 178 that are included in the excursion limiter circuit. In the depicted arrangement, the signal supplied by the commonly connected cathodes of diodes 166 and 174 is coupled to the anodes of like-poled diodes 180 and 182 of diode bridge 176 via series connected resistors 198, 200 and 202. The signal provided at the commonly connected cathodes of diodes 166 and 174 also is coupled to the anodes of like-poled diodes 188 and 190 of diode bridge 178 via a resistor 204. A capacitor 206 is connected from the junction between resistors 198 and 200 to the circuit negative supply voltage (−V_{cc}). A resistor 208 is connected between the negative supply voltage and the common junction between resistors 200, 202 and 204. The inverting input terminal of an operational amplifier 210 is connected to the common juncture of resistors 200, 202 and 204 via a resistor 212. The inverting input terminal of operational amplifier 210 is connected to circuit common, with a resistor 214 being connected between the output terminal of operational amplifier 210 and the operational amplifier inverting input terminal. In addition, the signal provided by operational amplifier 210 is coupled to the cathodes of commonly-poled diodes 184 and 186 in diode bridge 176 via a resistor 216 and also is coupled to the cathodes of like-poled diodes 192 and 194 of diode bridge 178 via a resistor 218. The junction between oppositely-poled diodes 180 and 184 of diode bridge 176 is connected to the noninverting input terminal of operational amplifier 144 of the adaptive low pass filter shown in FIG. 2 via a resistor 220 and the junction between oppositely-poled diodes 182 and 186 of diode bridge 176 is connected to signal common. To complete the interconnection of the excursion limiter of FIG. 12 with the depicted adaptive low pass filter, the output of the low pass filter is connected to oppositely poled diodes 188 and 192 of diode bridge 178, and oppositely poled diodes 190 and 194 of diode bridge 178 are connected to the junction between capacitors 140 and 142 of the adaptive low pass filter via a resistor 222.

In the above-described arrangement of FIG. 12 operational amplifier 150 and the associated passive components form a band-pass filter, which, in the currently preferred embodiments of the invention, exhibits corner frequencies of 80 and 160 Hz. The signal supplied by the band-pass filter arrangement is full-wave rectified by diodes 166 and 174 to supply current through the diodes of diode bridges 176 and 178. In this regard, the diodes of the diode bridges are operated in the non-linear portion of the diode current versus voltage range to in effect as voltage controlled resistors. In the sense of overall operation, the depicted arrangement exhibits psychoacoustic masking, employing an attack time that moves the corner frequency of the adaptive low pass filter without producing an audible indication of the circuit action.

FIG. 13 depicts a lower mid-range amplifier and an upper mid-range amplifier that are suitable for use as the lower mid-range amplifier 58 and upper mid-range amplifier 60 of FIGS. 6-8, with the lower mid-range and upper mid-range amplifiers of FIG. 13 being employed in the currently preferred embodiments of the invention. In the arrangement shown in FIG. 13, the lower mid-range amplifier includes an operational amplifier 230 with the noninverting input terminal thereof being connected for receiving the signal supplied by the adaptive low pass filter (54 in FIGS. 6-8) of an associated signal processing channel via series connected capacitors 232 and 234. Also connected between the input of the depicted lower mid-range amplifier and the noninverting input terminal of operational amplifier 230 is a resistor 236 which is connected in parallel with series connected resistors 238 and 240. A capacitor 242 and a resistor 244 are connected in series from the junction between resistors 238 and 240 to the junction between capacitors 232 and 234. Resistors 246 and 248 are connected in series between the inverting input terminal of operational amplifier and circuit common with the junction between resistors 246 and 248 being connected to the junction between capacitor 242 and resistor 244. Additionally, the inverting input terminal of operational amplifier 230 is directly connected to the operational amplifier output terminal. As was noted relative to the block diagrams of FIGS. 6-8, the circuit values of the lower mid-range amplifier are selected to reduce channel gain over a desired frequency band. In the currently preferred embodiments of the invention, the lower mid-range amplifier reduces gain over approximately a two-octave bandwidth that is centered at approximately 500 Hz.

The initial circuit stage of the upper mid-range amplifier depicted in FIG. 13 exhibits circuit topology identical to the topology of the depicted lower mid-range amplifier and includes an operational amplifier 254, capacitors 250, 252 and 262 and resistors 256, 258, 260, 262, 264, 266 and 268. The circuit values used in the depicted upper mid-range amplifier differ from the circuit values used in the lower mid-range amplifier so as to cause reduced channel gain over a frequency bandwidth that is higher than the frequency bandwidth for which the lower midrange amplifier is configured. In addition, the upper mid-range amplifier depicted in FIG. 13 includes a variable resistor 270 that is connected between the output terminal of operational amplifier 254 and the output of the upper mid-range amplifier. Connected in parallel with the variable resistor 270 are parallel connected capacitors 272 and 274. A series connected resistor 276 and capacitor 278 are connected between the output terminal of the upper mid-range amplifier and circuit common. As was noted in describing the upper mid-range amplifiers 60 of the left and right front signal processing channels, the center channel, and the left and right surround channels (FIGS. 6-8), in the currently preferred embodiments of the invention, the circuit values of the upper mid-range amplifiers are selected for reduced gain over approximately a two-octave frequency band that is centered at approximately 4 kHz.

FIG. 14 depicts the sibilance filter that is used in the currently preferred embodiments of the invention as the sibilance filters 62 in the block diagram arrangements described relative to FIGS. 6-8. In the depicted sibilance filter, the signal supplied by the upper mid-range amplifier is coupled to the inverting input terminal of an operational amplifier 280 via series connected resistors 282 and 284. A capacitor 286 is connected from the junction between resistor 282 and 284 and the output terminal of operational amplifier 280 to provide feedback to the operational amplifier noninverting input terminal. A resistor 288 and a parallel connected capacitor 290 are connected between the output terminal of operational amplifier 280 and the operational amplifier inverting input terminal. A resistor 292 is connected between circuit common and the inverting input terminal of operational amplifier 280. Series connected capacitor 294 and resistor 296 are connected from the noninverting input terminal of operational amplifier 280 to circuit common. As was described relevant to the sibilance filters 62 of FIGS. 6-8, the circuit value of sibilance filters employed in the practice of the invention are selected so that the sibilance filters at least partially eliminate the “s” sounds that sometimes occur in programming such as musical or other programs that include vocal content. In the currently preferred embodiments of the invention, resistors 282 and 284 are 39 kOhms, resistor 288 is 33 kOhms, resistor 292 is 120 kOhms, and resistor 296 is 30 kOhms. In this arrangement, capacitor 286 is 1 picofarad, capacitor 290 is 0.0047 microfarad, and capacitor 294 is 240 picofarad. These circuit values provide a single pole filter function with a corner frequency of approximately 12 kHz.

FIG. 15 illustrates an SPL limiter suitable for use as the SPL limiters 64 shown in block diagram form in FIGS. 6-8 and, in addition, depicts an SPL control circuit for controlling the operation of each SPL limiter that is used in the left and right front channel signal processing, the center channel processing, and the left and right surround channel signal processing. In the SPL limiter FIG. 15, the output of the sibilance filter of an associated signal channel is coupled to the inverting input terminal of an operational amplifier 300 via resistor 302, capacitor 304, and resistor 306, which are connected in series with one another. A resistor 308 is connected between the output terminal of operational amplifier 300 and the operational amplifier inverting input terminal. The noninverting input terminal of operational amplifier 300 is connected to signal common. The signal provided at the output of operational amplifier 300 is provided to the noninverting input terminal of an operational amplifier 310 with the inverting input terminal of operational amplifier 310 being connected to the operational amplifier output via a resistor 312 and being connected to circuit common via a resistor 314. The output terminal of operational amplifier 310 supplies an input signal to the SPL control circuit shown in FIG. 15 and is coupled to the output terminal of the SPL limiter via a resistor 316. In addition, the output terminal of operational amplifier 310 is connected to the noninverting input terminal of an operational amplifier 318 via a resistor 320 and is connected to the base electrode of a pnp transistor 322 via a resistor 324, a light-emitting diode 326 and a resistor 328, which are connected in series with one another. A resistor 330 is connected between circuit common and the junction between resistor 324 and light-emitting diode 326. A resistor 332 is connected between the output terminal of operational amplifier 318 and the operational amplifier inverting input terminal. The output terminal of operational amplifier 318 also is coupled to the base electrode of pnp transistor 322 via series connected resistor 334, light-emitting diode 336 and resistor 328. A resistor 338 is connected from the junction between resistor 334 and the anode of light-emitting diode 336 to circuit common. Bias for pnp transistor 322 is provided by a voltage divider that is formed by resistors 340 and 342 that are connected between circuit common and the circuit positive supply voltage (+V_{cc}), with the junction between resistors 340 and 342 being connected to the junction between resistor 328 and the cathodes of light-emitting diodes 326 and 336 via a resistor 344. The control signal supplied by the SPL control circuit of FIG. 15 is coupled to the output terminal of the depicted SPL limiter with a resistor 346 being connected from the output terminal of the SPL limiter via a resistor 246.

Turning to the SPL control circuit of FIG. 15, the signal produced at the output terminal of operational amplifier 310 of the SPL limiter is coupled to the inverting input terminal of an operational amplifier 350 by means of a signal path consisting of a resistor 352 that is connected to the cathode of a diode 354 and a resistor 356 that is connected to the anode of the diode 354. As is indicated in FIG. 15, additional resistors 352 and diodes 354 are connected to resistor 356 to provide signals from the SPL limiters of the various other signal processing channels being employed in a particular embodiment of the invention. Continuing with the description of the SPL control circuit of FIG. 15, the parallel connected combination of a resistor 358 and a capacitor 360 is connected from the junction between the anodes of diodes 354 and resistor 356 to circuit common. A capacitor 362 is connected between the inverting input terminal of operational amplifier 350 and circuit common. A resistor 364 is connected between the output terminal of operational amplifier 350 and the operational amplifier inverting input terminal. The noninverting input terminal of operational amplifier 350 is connected to the junction between resistors 366 and 368, which form a voltage divider connected between the circuit negative supply voltage (−V_{cc}) and circuit common.

As previously noted, the currently preferred embodiments of the invention employ an SPL control circuit that controls each SPL limiter of a particular embodiment of the invention. For example, in a full surround sound embodiment of the invention, five SPL limiters are employed to provide sound pressure limiting of the speaker units 10 of the left and right front channels, the center channel, and the left and right surround channels. In the arrangement of FIG. 15, the SPL control signal is provided by a npn transistor having the emitter electrode thereof connected to circuit common and the collector electrode thereof connected to the output terminal of the associated SPL limiter. The base electrode npn transistor 370 is connected to the output terminal of operational amplifier 350 of the SPL control circuit via a resistor 372 with the junction between the output terminal of operational amplifier 350 and resistor 372 being connected to circuit common via a series connected resistor 374 and light-emitting diode 378. As is indicated by the dashed lines in FIG. 15, an output stage consisting of a transistor 370, resistors 372 and 374, and a light-emitting diode 378 is provided to control each SPL limiter employed in a particular embodiment of the invention. In that regard, in some situations the invention may be embodied as a stereophonic (two-channel system or even a seven-channel system (having additional left and right side channels)) instead of a five-channel surround sound system.

As noted previously, each SPL limiter and the SPL control circuit operate to reduce the gain of the SPL limiter when the amplifier channel of the amplifier that drives the associated speaker unit 10 is clipping or, preferably, is on the verge of clipping. Thus, the SPL limiter is what is sometimes referred to in the art as an infinite signal compressor. In the currently preferred embodiments of the invention, the SPL limiter exhibits unity gain (0 dB) until the signal supplied by the SPL limiter reaches approximately 2 volts rms. For signals exceeding 2 volts rms, conduction of transistor 370 is controlled to decrease the gain of the SPL limiter by 1 dB for each 1 dB increase in the signal supplied to the SPL control circuit.

The SPL control circuit shown in FIG. 15 also provides protection for the woofers 12 if one or all of the woofers are being drive at a high level for a period of time that is likely to cause voice coil overheating. Specifically, the circuit values for resistors 356 and 358 and capacitors 360 and 362 are selected so that the half-wave rectified signals supplied via resistors 352 and diodes 354 are integrated by capacitor 362. If the supplied signal is at a high level for a sufficient amount of time (capacitor 362 not able to sufficiently discharge during low level portions of the input signal) the voltage across capacitor 362 causes increased current to flow through the collector to emitter path of npn transistor 370. The increased current flow reduces the gain of the SPL limiter to a point at which the signal supplied to the woofers 12 will prevent the temperature of the voice coils from becoming too high. In the currently preferred embodiment of the arrangement of FIG. 15, the voltage gain of that SPL limiter is reduced by a factor of 4, when capacitor 362, reaches the point at which voice coil overheating is occurring or may occur.

FIG. 15 also depicts a circuit arrangement for generating a signal that will automatically turn on the speaker system of the invention if an audio signal is present in any of the system channels. In the depicted arrangement, the signal supplied to the above-described SPL control circuit by each channel of the speaker system also is coupled to a capacitor 380 by resistors 382 that are connected to receive a signal from the output of operational amplifier 310 of each system channel. As is shown in FIG. 15, the receive signals are coupled to the inverting input terminal of an operational amplifier 384 via the capacitor 380. The noninverting input terminal of operational amplifier 384 is connected to circuit common and a resistor 386 is connected between the output terminal of operational amplifier 384 and the operational amplifier noninverting input terminal. The signal produced at the output terminal of operational amplifier 384 is supplied to the inverting input terminal of an operational amplifier 396 by means of a circuit path that includes a resistor 388 connected from the output terminal of operational amplifier 384 to the commonly connected anodes of parallel connected diodes 390 and 392 and a resistor 394 that is connected between the commonly connected cathodes of diodes 390 and 392 and the inverting input terminal of operational amplifier 396. A resistor 404 is connected from the output terminal of operational amplifier 396 to the operational amplifier noninverting input terminal, with the noninverting input terminal also being connected to the junction between resistors 402 and 406, which form a voltage divider between the positive circuit supply voltage (+V_{cc}) and circuit common. The output of operational amplifier 396 is provided via a resistor 406. In the arrangement shown in FIG. 15, the output signal provided by operational amplifier 396 is at a positive voltage when signal is present in one or more channels of the speaker system.

FIG. 16 depicts a tone amplifier suitable for use as the tone amplifiers 66 depicted in the channel processing block diagrams of FIGS. 6-8. In the arrangement of FIG. 16, the signal supplied by the SPL limiter of an associated signal processing channel is connected to the noninverting input terminal of an operational amplifier 420. The output terminal of operational amplifier 420 is connected to supply the output signal of the tone amplifier and is coupled to the operational amplifier inverting input terminal via a resistor 422. The inverting input terminal of operational amplifier 420 is connected to circuit common via a resistor 424 and, in addition, is connected to the wiper terminal of a variable resistor 426 via the series connected combination of a resistor 428 and capacitor 430. Variable resistor 426 is connected between the output terminal of operational amplifier 420 and circuit common. As noted, with respect to the tone amplifiers 66 described relative to the block diagrams of FIGS. 6-8, the tone amplifier of FIG. 16 serves as a high-frequency trim circuit. In the arrangement shown in FIG. 16, variable resistor 426 provides a maximum of 6 dB per octave boost for frequencies above about 4 kHz.

FIG. 17 depicts a floorbounce amplifier suitable for use as the floorbounce amplifiers of the block diagram arrangements shown in FIGS. 6-8. In the floorbounce amplifier of FIG. 17, the signal supplied by the tone amplifier of an associated channel is coupled to the noninverting input terminal of an operational amplifier 440 via a resistor 442. Connected in parallel with resistor 440 is the series combination of resistors 444 and 446. Also connected in parallel with resistor 442 is the series connected combination of capacitors 452 and 454. Connected from the junction of resistor 444 and resistor 446 to the junction between capacitor 452 and 454 is a series connected combination of a capacitor 448 and a resistor 450. The inverting input terminal of operational amplifier 440 is directly connected to the operational amplifier output terminal and, in addition, is connected to circuit common via series connected resistors 456 and 458. The junction between resistors 456 and 458 is directly connected to the junction between series connected capacitor 448 and resistor 450. A capacitor 460 that is connected to the output terminal of operational amplifier 440 supplies the floorbounce amplifier output signal. As was noted relative to describing the floorbounce amplifiers of FIGS. 6-8, the signal transfer characteristics of the floorbounce amplifiers are established to reduce the amplitude of low frequency signals generated by the woofers 12 and supplied to the associated speaker units 10 to thereby at least partially eliminate reflection of signals from the floor of the listening area. Preferably, the floorbounce amplifier of FIG. 17 and equivalent circuits that can be used in the practice of the invention exhibit reduced signal gain over a frequency range of about 1½ to about 1 octave, with the center frequency being on the order of 200 Hz and the mid-band attenuation being on the order of 3 dB.

FIG. 17 illustrates one arrangement that can be used as the output stages 70 described relative to the circuit block diagrams of FIGS. 6-9. The output stage of FIG. 18 includes an unbalanced connector 470 (such as an RCA connector) having the outer conductor or shield connected to signal common and the center conductor connected to the output stage input signal via a resistor 472. A balanced signal output connector 474 (such as an XLR connector) is also provided in the circuit of FIG. 18, with one contact being connected to signal common and a second contact being connected to the input of the output stage via resistor 472. The third contact of the balanced output connector is connected to signal common via resistor 476 and is connected to the output terminal of an operational amplifier 482 via the series connected combination of a capacitor 478 and a resistor 480. Connected between the inverting input terminal of operational amplifier 482 and the input of the output stage 80 is a resistor 486, with a resistor 484 being connected between the operational amplifier inverting input terminal and the operational amplifier output terminal. The noninverting input terminal of operational amplifier 482 is connected to signal common. In this arrangement, resistors 476, 484 and 486 are of equal resistance value (20 kOhms in the currently preferred arrangement) and resistors 472 and 480 are of equal value (620 Ohms in the currently preferred arrangements) to provide the desired combination of unbalanced and balanced signal outputs.

As was described relative to the block diagram arrangements of FIGS. 7, 8 and 9, the center channels, left and right surround channels, and subwoofer channel of embodiments of the invention that are configured for surround sound programming preferably include surround switches (72 in FIGS. 7-9) that receive signals from an accent matrix circuit to synthesize surround sound programming when stereophonic programming is being supplied to the system. An accent matrix circuit suitable for use in embodiments of the invention that synthesize or transform stereophonic programming to surround sound programming is shown in FIG. 19. In the arrangement of FIG. 19, the circuitry for producing a synthesized left surround channel signal includes operational amplifiers 490 and 492, resistors 494, 496, 498 and 500, and a variable resistor 502 for setting the signal level provided to the associated surround switch. In this arrangement, the noninverting input terminals of operational amplifiers 490 and 492 are connected to circuit common and the signals supplied from the left front channel input stage 50 is connected to the inverting input terminal of operational amplifier 490 via resistor 494. The inverting input terminal also is connected to the operational amplifier output terminal via resistor 500. Resistor 496 couples the output signal supplied by operational amplifier 490 to the inverting input terminal of operational amplifier 492. Also supplied to the inverting input terminal of operational amplifier 492 is the signal supplied from the input stage 50 of the right front channel (via resistor 498). A variable resistor 502 connected between the output terminal of operational amplifier 492 and the inverting input terminal of the operational amplifier provides adjustment of the output signal level and hence, controls the level of the signal coupled to the surround switch of the left surround channel (which is taken at the output terminal of operational amplifier 492).

The circuitry of FIG. 19 for synthesizing a right surround channel signal in effect is the “mirror image” of the above-described circuitry for synthesizing a left surround sound channel. Specifically, in the arrangement of FIG. 19, the signal supplied by the right front channel is connected to the noninverting input terminal of an operational amplifier 504 via a resistor 506, with the inverting input terminal of the operational amplifier being connected to circuit common. A resistor 508 is connected between the noninverting input terminal of operational amplifier 504 and the operational amplifier output terminal. A resistor 510 connects the output terminal of operational amplifier 504 to the inverting input terminal of an operational amplifier 512, having the noninverting input terminal thereof connected to circuit common. The signal supplied by the input stage 50 of the left front input channel is also coupled to the inverting input terminal of operational amplifier 512 (via a resistor 514). A variable resistor 516 connected between the output terminal of operational amplifier 512 and the inverting operational amplifier input terminal controls the level of the signal supplied by the depicted accent matrix circuit to the surround switch of the right surround channel.

To provide a synthesized center channel signal and a synthesized subwoofer signal, the accent matrix arrangement of FIG. 19 includes equal value resistors 520 and 522 that are connected in series between the input terminal of the accent matrix circuit that receives the left front channel signal and the input terminal that receives the right front channel signal. Variable resistors 524 and 526 are connected in parallel with one another between the junction of resistor 520 and 522 and circuit common. The wiper contact of variable resistor 526 provides the synthesized subwoofer signal. The noninverting input terminal of an operational amplifier 528 that provides the synthesized center channel signal is connected to the wiper contact of variable resistor 524 with the noninverting input terminal of operational amplifier 528 also being connected to circuit common via a resistor 530. In this arrangement, the inverting input terminal of operational amplifier 528 is directly connected to the output terminal of the operational amplifier.

It should be recognized that various changes can be made in the herein described currently preferred embodiments of the invention without departing from the scope and spirit of the invention. For example, both the woofers 12 and the folded ribbon speaker 14 can be of different physical size and can be configured for operation at a sound output level that differs from the maximum sound output level of the currently preferred embodiments. In many respects, changing the size of components used in the invention and the maximum output power level is a matter of scaling that is well within the capabilities of those of ordinary skill in the art. For example, and as previously described, in accordance with the invention, the product of the magnetic field produced in the magnetic gap of the woofers 12 and the length of the voice coil winding is relatively high in order for the woofers 12 to operate within a small sealed enclosure. However, the required Bl product is determined in large part by speaker size (effective piston area) and the design value for the maximum sound pressure level that is to be generated by each speaker unit 10. Moreover, since the product of B and l establishes woofer back emf and prevents voice coil overheating while providing the desired maximum output sound levels, the value of the magnetic field, B, and the length of the voice coil winding, l, can be varied to a certain degree for a particular desired value of Bl. Various known considerations relating to the construction of the woofer voice coils such as wire gauge and the length of the voice coil winding determine the voice coil DC resistance. Thus, the DC resistance of the woofers 12 can be established at a particular design value by varying the winding characteristics of the voice coil. With regard to these parameters, the preferred embodiments of the invention exhibit a value of (Bl)²/rₑ that is within a range that extends from approximately 10 to about 12. Similar considerations are applicable to the folded ribbon speakers 14 and system circuitry.

It also will be recognized by those skilled in the art that the various circuit stages described herein are exemplary in nature. That is, other arrangements can be used to serve the same filtering, amplification and control functions described relative to the disclosed circuit stages.

The embodiments of the invention in which an exclusive property or privilege is claimed are defined as follows:

1. A speaker unit for use in a multi-channel speaker system, said speaker unit including a housing having a front panel, left and right side panels, a back panel and top and bottom panels;
a first and second woofer that are mounted within the interior of said housing with said first woofer being mounted to said left side panel and said second panel being mounted to said right side panel, with the region within which said first and second woofers are mounted being substantially sealed and said first and second woofers being configured to operate with relatively high voice coil excursion that establishes pressures within said sealed region of said housing that exceed 0.2 lbs/in² during periods of maximum peak-to-peak voice coil excursion; and
a folded ribbon loudspeaker mounted to the front panel of said speaker housing.

2. A multi-channel speaker system wherein each channel includes a speaker unit defined by claim 1, and wherein each channel further comprises signal processing circuitry for receiving an audio signal and for controlling the amplitude and frequency content of the audio signal to allow said woofers to be driven at maximum voice coil excursions that establish pressures within the sealed region of said speaker unit housing that exceeds 0.2 lbs/in² over the full frequency response range of said multi-channel speaker system.

3. The multi-channel speaker system of claim 2 wherein said signal processing circuitry includes an adaptive low pass filter connected to receive a signal representative of the signal being supplied to said signal processing circuitry and further includes an excursion limiter circuit connected to receive a signal representative of the signal being supplied to said signal processing circuitry, said excursion limiter being connected to said adaptive low pass filter and being operative to reduce the gain of said adaptive low pass filter over a predetermined frequency range when the signal supplied to said excursion limiter includes a signal within said predetermined frequency range that exceeds a predetermined level.

4. The multi-channel speaker system of claim 3 wherein the signal processing circuitry of each channel further includes a sound pressure level limiter and a sound pressure level control circuit, said sound pressure level control circuit being connected to said sound pressure level limiter for reducing the gain of said sound pressure level limiter when the signal supplied to said sound pressure level limiter reaches a level at which the signal supplied to the woofers associated with the signal processing channel exhibit signal clipping.

5. The multi-channel speaker system of claim 4 wherein left and right front channels, a center channel, and left and right surround channels are provided for use with surround sound programming and wherein said multi-channel speaker system further comprises an accent matrix circuit for receiving signals from the signal processing circuitry associated with the left and right front channels and processing said signals to synthesize a center channel signal and left and right surround sound signals when stereophonic audio programming is supplied to said signal processing circuits for said left front and right front channels.

6. The multi-channel speaker system of claim 5 wherein said accent matrix circuit further includes a circuit for receiving signals representative of signals supplied to said left and right front channels when stereophonic programming is supplied to said multi-channel speaker system and includes circuitry for synthesizing a subwoofer channel signal.

7. The multi-channel speaker system of claim 2 wherein the signal processing circuitry of each channel further includes a sound pressure level limiter and a sound pressure level control circuit, said sound pressure level control circuit being connected to said sound pressure level limiter for reducing the gain of said sound pressure level limiter when the signal supplied to said sound pressure level limiter reaches a level at which the signal supplied to the woofers associated with the signal processing channel exhibit signal clipping.

8. The multi-channel speaker system of claim 2 wherein left and right front channels, a center channel, and left and right surround channels are provided for use with surround sound programming and wherein said multi-channel speaker system further comprises an accent matrix circuit for receiving signals from the signal processing circuitry associated with the left and right front channels and processing said signals to synthesize a center channel signal and left and right surround sound signals when stereophonic audio programming is supplied to said signal processing circuits for said left front and right front channels.

9. The multi-channel speaker system of claim 8 wherein said accent matrix circuit further includes a circuit for receiving signals representative of signals supplied to said left and right front channels when stereophonic programming is supplied to said multi-channel speaker system and includes circuitry for synthesizing a subwoofer channel signal.
